(19) United States
(12) Patent Application Publication
(10) Pub. No.: US 2013/0144534 A1
(43) Pub. Date: Jun. 6, 2013

(54) Multi-Component Spectral Warping Analysis for Thin Bed Resolution

(71) Applicants: Fred Hilterman, Houston, TX (US); James Gaiser, Del Mar, CA (US)

(72) Inventors: Fred Hilterman, Houston, TX (US); James Gaiser, Del Mar, CA (US)

(73) Assignee: Geokinetics Acquisition Company, Houston, TX (US)

(21) Appl. No.: 13/310,747

(22) Filed: Dec. 3, 2011

(51) Int. Cl. G06F 19/00; G01V 1/30

(52) U.S. Cl. 702/18

(57) ABSTRACT

A characteristic of a target layer is determined by receiving primary wave data and secondary wave data from multi-component receivers for acquiring both primary wave data and secondary wave data in a seismic exploration system, calculating a Vp/Vs ratio by correlating in a frequency domain a number of estimated primary wave spectra derived from a measured secondary wave spectrum to a measured primary wave spectrum, wherein Vp is a first velocity of a primary wave and Vs is a second velocity of a secondary wave for a target depth interval, using a warp factor associated with the Vp/Vs ratio, calculating a time separation for primary wave signals from a top and a bottom of the target depth interval.

### BACKGROUND OF THE INVENTION

1. Field of the Invention

The invention disclosed and claimed herein pertains to analysis of multi-component geophysical data involving primary waves and secondary waves. More particularly, the invention pertains to determining a ratio of primary wave velocity to secondary wave velocity (Vp/Vs) using estimated primary wave spectra from a measured secondary wave spectrum and a measured primary wave spectrum.

2. Description of the Related Art

Scientists and engineers often employ seismic surveys for exploration, archeological studies, and engineering projects. Seismic surveys can provide information about underground structures, including formation boundaries, rock types, and the presence or absence of fluid reservoirs. Such information aids searches for water, geothermal reservoirs, and mineral deposits such as hydrocarbons and ores. Oil companies in particular often invest in extensive seismic surveys to select sites for exploratory oil wells.

Conventional seismic surveys employ artificial seismic energy sources such as shot charges, air guns, or vibratory sources to generate seismic waves. The sources, when initiated, create a seismic “wavelet”, i.e., a pulse of seismic energy that propagates as seismic waves from the source down into the earth. Faults and boundaries between different formations create differences in acoustic and shear impedances that cause reflections of the seismic waves. A seismic sensor array detects and records these reflections for later analysis. Sophisticated processing techniques are applied to the recorded signals to extract an image of the subsurface structure.

A seismic sensor array may acquire multi-component data by measuring both horizontal deflections and vertical deflections in response to interception of seismic energy that is reflected back to the surface. A seismic wave may be divided into two wave types based on the direction of propagation of the seismic wave relative to a direction that particles in the medium are displaced during propagation. Those two wave types may be primary waves and secondary waves.

Primary waves propagate at a higher velocity than secondary waves, and the difference in velocities may be expressed as a ratio. The ratio of primary wave velocity to secondary wave velocity (Vp/Vs) is a useful tool for interpreting acquired seismic data. For example, a numerical value for the Vp/Vs ratio may inform a seismic engineer as to one or more characteristics of a target. A target may be a layer in the earth referred to as a bed. A bed may be a thick bed or a thin bed. When a thickness of a bed is less than one quarter of the wavelength of the seismic wavelet, the bed is considered “thin” relative to that frequency, and may be referred to as a “thin bed.” A thick bed may be a bed where the thickness is greater than one quarter of the wavelength of the seismic wavelet.

In order to calculate a Vp/Vs ratio, data must be analyzed in one domain. Normally, that domain is the time domain, and analysis of primary wave data and secondary wave data requires registration of each data set. Spectral registration involves “stretching” the secondary wave data spectrum by a combination of filtering and warping. Filtering involves reducing noise and equalizing the spectrum of the primary seismic wavelet and the secondary seismic wavelet. Warping involves moving data at each frequency point in the secondary wave data spectrum to a frequency multiplied by a value to align the secondary wave data spectrum with a corresponding event in the primary wave data spectrum. Because the secondary waves travel more slowly than the primary waves, a “squeezing” of the secondary wave data in the time domain to register to the primary wave data in the time domain results in loss of detail. Consequently, as a layer gets thinner, target features may not be identifiable and a Vp/Vs ratio may not be identifiable. Indeed, for layers less than a quarter wavelength, a Vp/Vs ratio may not be identifiable using time domain analysis.

Therefore, it would advantageous to have a method and apparatus that takes into account at least some of the issues discussed above as well as possibly other issues.

### SUMMARY OF THE INVENTION

In an illustrative embodiment, a method for determining a characteristic of a target layer comprises: a computer receiving primary wave data and secondary wave data from multi-component receivers for acquiring both primary wave data and secondary wave data in a seismic exploration system, the computer calculating a Vp/Vs ratio by correlating in a frequency domain a number of estimated primary wave spectra derived from a measured secondary wave spectrum to a measured primary wave spectrum, wherein Vp is a first velocity of a primary wave and Vs is a second velocity of a secondary wave for a target depth interval, and the computer, using a warp factor associated with the Vp/Vs ratio, calculating a time separation for primary wave signals from a top and a bottom of the target depth interval.

In an another embodiment, a method for determining a characteristic of a target layer comprises: a computer receiving primary wave data and secondary wave data from multi-component receivers for acquiring both primary wave data and secondary wave data in a seismic exploration system; the computer calculating a Vp/Vs ratio by correlating in the frequency domain a number of estimated secondary wave spectra derived from the measured primary wave spectrum to the measured secondary wave spectrum, wherein Vp is a first velocity of the primary wave and Vs is a second velocity of the secondary wave for a target depth interval, and the computer, using a warp factor associated with the Vp/Vs ratio, calculating a time separation for primary wave signals from a top and a bottom of the target depth interval.

The features, functions, and advantages can be achieved independently in various embodiments of the present disclosure or may be combined in yet other embodiments in which further details can be seen with reference to the following description and drawings.

### BRIEF DESCRIPTION OF THE DRAWINGS

FIG. 1 is an illustration of a seismic exploration environment in accordance with an illustrative embodiment.

FIG. 2 is an illustration of a seismic analysis system in accordance with an illustrative embodiment.

FIG. 3 is an illustration of a depth model in accordance with an illustrative embodiment.

FIG. 4 is an illustration of a flow chart for transforming data in accordance with an illustrative embodiment.

FIG. 5 is an illustration of a flow chart for determining ratios in accordance an illustrative embodiment.

FIG. 6 is an illustration of a flow chart for determining time separations in accordance with an illustrative embodiment.

FIG. 7 is an illustration of a flow chart for configuring a seismic analysis system in accordance with an illustrative embodiment.

FIG. 8 is an illustration of a primary signal in the time domain with its corresponding frequency spectrum in accordance with an illustrative embodiment.

FIG. 9 is an illustration of a secondary signal in the time domain with its corresponding frequency spectrum in the frequency domain in accordance with an illustrative embodiment.

FIG. 10 is an illustration of a thick bed primary signal in the time domain and its corresponding frequency spectrum in accordance with an illustrative embodiment.

FIG. 11 is an illustration of a thick bed secondary signal in the time domain and its corresponding frequency spectrum in accordance with an illustrative embodiment.

FIG. 12 is an illustration of a plot of correlation values versus trial Vp/Vs ratios in accordance with an illustrative embodiment.

FIG. 13 is an illustration of a thick bed primary signal in the time domain and its corresponding frequency spectrum in accordance with an illustrative embodiment.

FIG. 14 is an illustration of a thick bed secondary signal in the time domain and its corresponding frequency spectrum in accordance with an illustrative embodiment.

FIG. 15 is an illustration of a plot of correlation values versus trial Vp/Vs ratios in accordance with an illustrative embodiment.

FIG. 16 is an illustration of a thin bed primary signal with an Ormsby filter in the time domain and its corresponding frequency spectrum in accordance with an illustrative embodiment.

FIG. 17 is an illustration of a thin bed secondary signal with an Ormsby filter in the time domain and its corresponding frequency spectrum in accordance with an illustrative embodiment.

FIG. 18 is an illustration of a plot of correlation values versus trial Vp/Vs ratios in accordance with an illustrative embodiment.

FIG. 19 is an illustration of a series of thin-bed reflections with varying two-wave travel times between a top and a bottom boundary in accordance with an illustrative embodiment.

FIG. 20 is an illustration of a data processing system in accordance with an illustrative embodiment.

### DETAILED DESCRIPTION OF THE PREFERRED EMBODIMENT

The description of the different advantageous embodiments has been presented for purposes of illustration and description, and is not intended to be exhaustive or limited to the embodiments in the form disclosed. Many modifications and variations will be apparent to those of ordinary skill in the art. Further, different embodiments may provide different advantages as compared to other embodiments. The embodiment or embodiments selected are chosen and described in order to best explain the principles of the invention, the practical application, and to enable others of ordinary skill in the art to understand the invention for various embodiments with various modifications as are suited to the particular use contemplated.

Persons skilled in the art recognize and take into account that primary waves may be referred to as compressional waves or P-waves, and that secondary waves may be referred to as shear waves, PS-waves, S-waves or C-waves. For example, primary wave energy may be converted to shear wave energy when a primary wave traveling in a medium encounters an impedance boundary and is reflected as a secondary wave. Persons skilled in the art recognize and take into account that additional terms and notations may be used to designate primary waves and secondary waves.

Persons skilled in the art recognize and take into account that primary wave particles in a medium move parallel to a propagation direction, and secondary wave particles in the medium move perpendicular to the propagation direction. Persons skilled in the art recognize and take into account that for a given medium, primary waves propagate at a higher velocity than secondary waves.

Persons skilled in the art recognize and take into account that an image of a subsurface structure may indicate a potential oil or gas reservoir, and a ratio of a Vp/Vs ratio may allow a seismic engineer to make informed judgments regarding morphology, porosity, water saturation and anisotropy of the target. Thus a Vp/Vs ratio may be used to select a target for additional data analysis to further define the characteristics of the target.

Persons skilled in the art recognize and take into account that in order to interpret primary wave data and secondary wave data together, the data must be interpreted in the same domain. Typically, a single reflecting event is identified in both the primary wave data and the secondary wave data by manual or computer correlation. Because secondary wave velocities are lower than primary wave velocities, time scaling is required to correlate the data in the time domain. Such time scaling may be referred to as “registration.” Registration involves filtering the data to remove ringing and noise and then “squeezing” the secondary wave data in the time domain to match the primary wave data in the time domain. However, certain features may not be identifiable at certain depth intervals because a peak and trough in the primary wave data may come too close together. For example, “thin beds” or layers less than a quarter wavelength thick may not be identifiable in the time domain, and therefore, a Vp/Vs ratio derived from the time domain may not be available to aid in decision making.

Therefore, persons skilled in the art recognize and take into account that it is desirable for seismic engineers to be able to derive a Vp/Vs ratio for layers less than a quarter wavelength thick

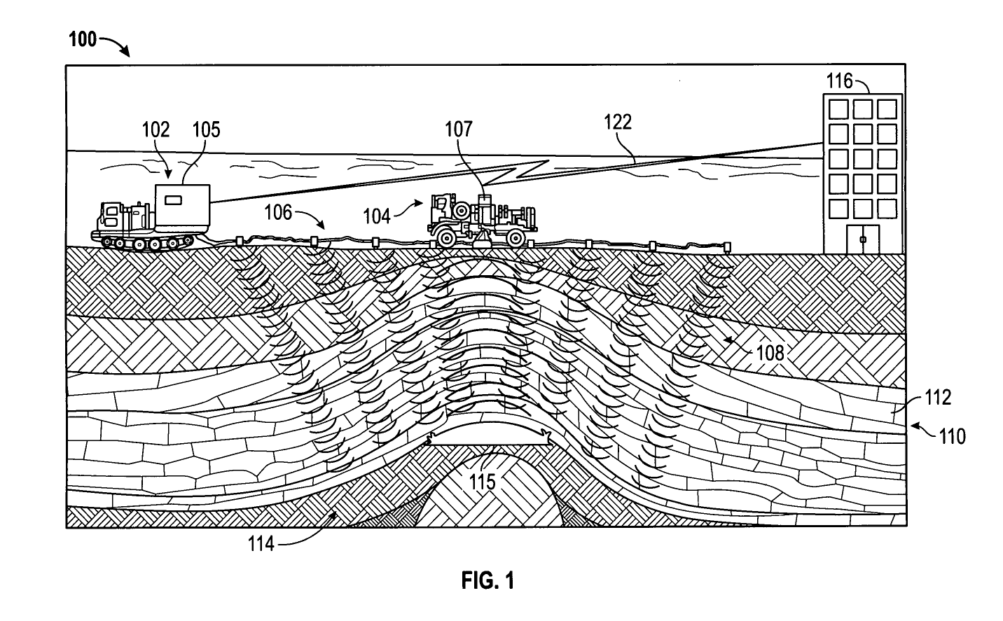

With reference now to the figures and, in particular with reference to FIG. 1, an illustration of a seismic exploration environment is depicted in accordance with an advantageous embodiment. In this illustrative example, seismic exploration environment 100 is an example of an environment in which an illustrative embodiment may be implemented. In this depicted example, seismic exploration environment 100 includes seismic source 104 and seismic recorder 102. In this illustrative example, seismic source 104 comprises vibrator truck 107 that controls a vibrating source plate. Vibrator truck 107 is configured to generate controlled seismic energy to cause vibrations 108 to travel through earth 110.

In these illustrative examples, seismic recorder 102 takes the form of a recorder truck 105 that is configured to detect vibrations 108 as vibrations 108 reflect off of subsurface formations 112 such as layers of rock. In this illustrative example, vibrations 108 may reflect off of layer 114 in subsurface formations 112 in earth 110. In these illustrative examples, layer 114 may contain desired resources 115. Desired resources 115 may be, for example, such as natural gas, hydrocarbons, and other suitable resources.

In these illustrative examples, seismic recorder 102 may transmit seismic data gathered from detecting vibrations 108 to analysis station 116 over wireless communications link 122. Analysis station 116 is configured to analyze the seismic data. The seismic data is analyzed to identify the location of layer 114 that may contain the desired resources 115.

In these illustrative examples, the seismic data detected by seismic recorder 102 may include data about primary waves and secondary waves. Primary waves are longitudinal in nature. The secondary waves are transverse in nature. The secondary waves travel slower than the primary waves within earth 110. As a result, the data for secondary waves may be recorded by seismic recorder 102 after the primary waves are detected for the same feature. For example, primary waves for layer 114 may be detected prior to secondary waves reflecting off of layer 114.

The illustration of seismic exploration environment in FIG. 1 is not meant to imply physical or architectural limitations to the manner in which an advantageous embodiment may be implemented. For example, the different advantageous embodiments may be implemented in an ocean environment rather than on the land to obtain seismic data about subsurface formations under the surface of the floor of the ocean.

As another illustrative example, although seismic source 104 employs vibrator truck 107 to generate vibrations 108 in earth 110, other devices may be used to generate vibrations 108. For example, these devices may be selected from one or more of an air gun, a plasma sound source, a dynamite source, a thumper, and other suitable devices.

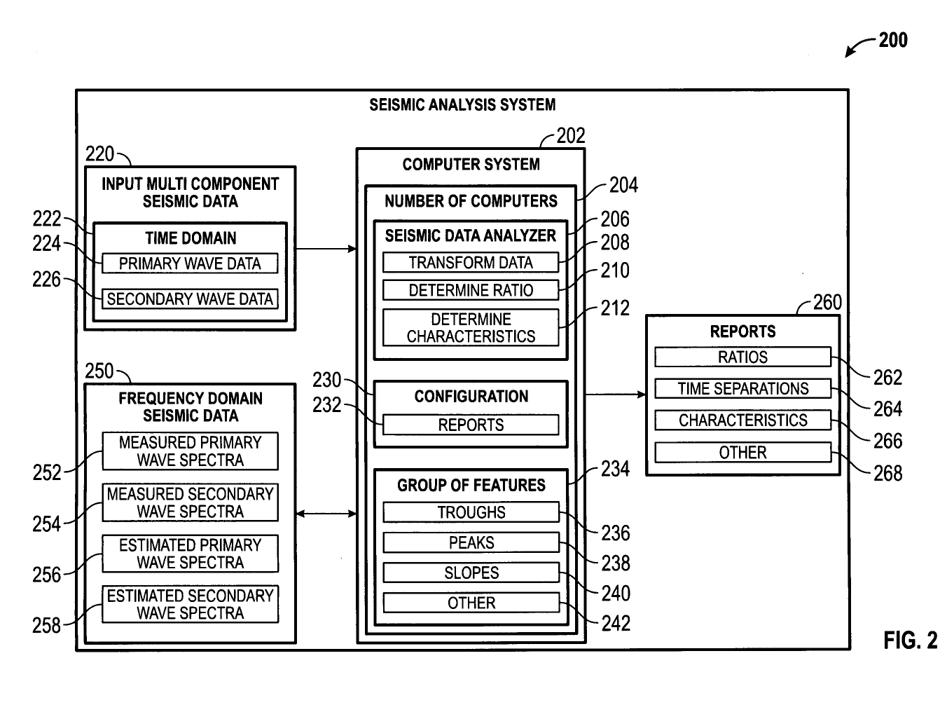

With reference now to FIG. 2, an illustration of a seismic analysis system is depicted in accordance with an advantageous embodiment. In this illustrative example, seismic analysis system 200 is an example of an analysis system that may be located in analysis station 116.

In this illustrative example, seismic analysis system 200 comprises computer system 202. Computer system 202 may have number of computers 204. In these illustrative examples, number of computers 204 may be one or more computers. When computer system 202 includes more than one computer, these computers may be in communication with each other. This communication may be provided by a mechanism such as a local area network, a wide area network, an intranet, an internet, or some other suitable communications mechanism. In these illustrative examples, seismic data analyzer 206 may be implemented as software, hardware, or a combination of the two.

As depicted seismic data analyzer 206 and configuration component 230 may be implemented in computer system 202. In these illustrative examples, seismic data analyzer 206 receives input multi-component seismic data 220. Input multi-component seismic data 220 may be received from a source such as seismic recorder 102 in FIG. 1.

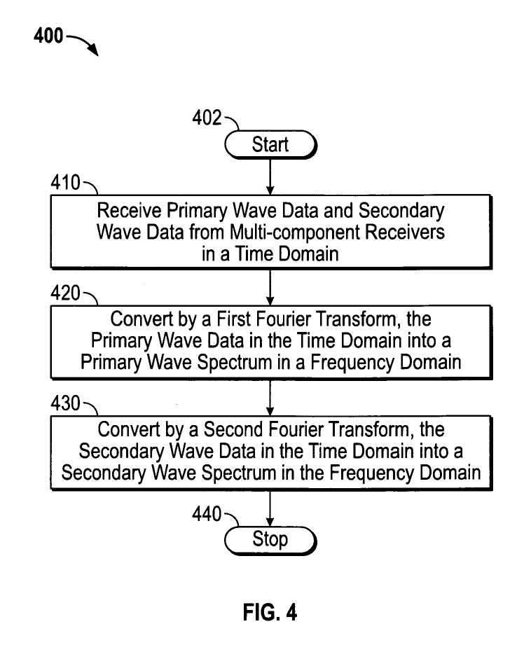

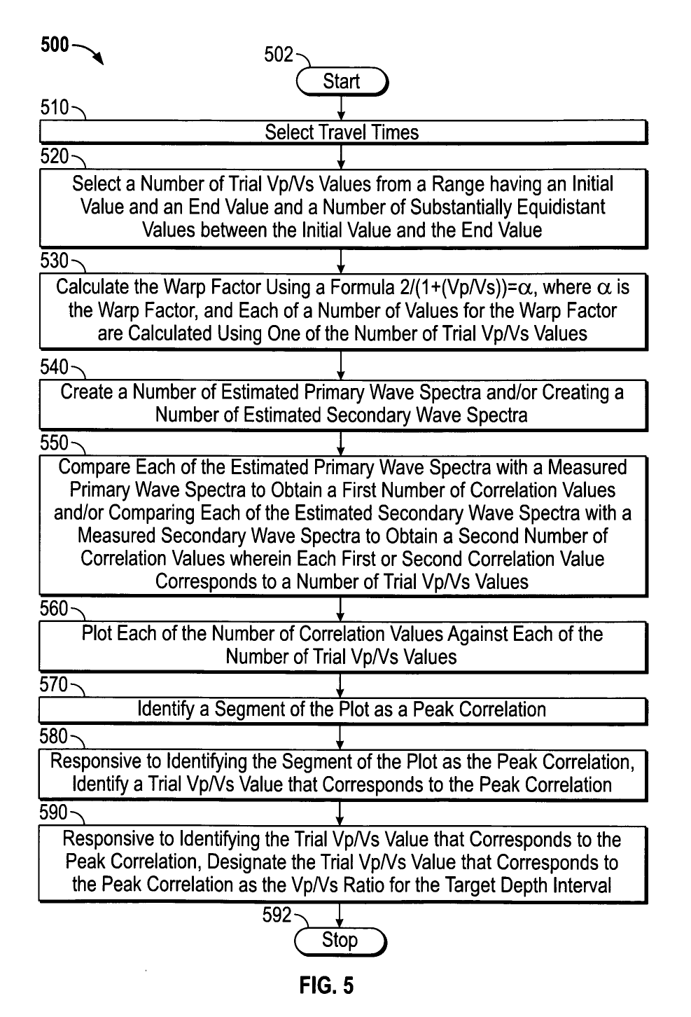

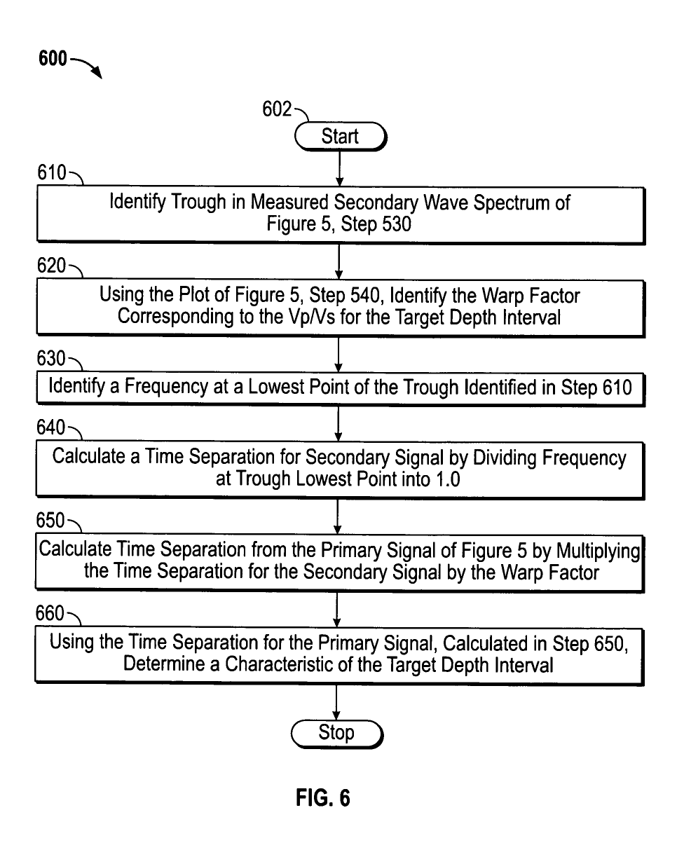

As depicted, input multi-component seismic data 220 may be in time domain 222. Time domain 222 may include primary wave data 224 and secondary wave data 226. Primary wave data 224 and secondary wave data 226 in time domain 222 may be analyzed by seismic data analyzer 206. Seismic data analyzer 206 may include transform data component 208, determine ratio component 210, and determine characteristic component 212. Transform data component 208 may cause one or more of number of computers 204 in computer system 202 to perform the method illustrated in FIG. 4. Determine ratio component 210 may cause one or more of number of computers 204 in computer system 202 to perform the method illustrated in FIG. 5. Determine characteristic component 212 may cause one or more of number of computers 204 in computer system 202 to perform the method illustrated in FIG. 6. Seismic data analyzer 206 may be configured to produce reports 260. Reports 260 may include ratios 262, time separations 264, and characteristics 266.

Ratios 262 may be determined by determine ratio component 210. Ratios 262 may be used to determine characteristics of a target interval such as characteristics 266. Time separations may be determined by determine characteristic component 212. Time separations 264 may be used by determine characteristic component 212 to determine one or more characteristics of a target interval. In these illustrative embodiments a target interval may be a thin bed. Reports may also include other reports 268 in accordance with reports component 232 of configuration component 230. Reports 260 may be printed or displayed as configured by reports component 232 in configuration component 230 in computer systems 202. Reports 260 may identify characteristics 266 of subsurface structures based on processing of input multi-component seismic data 220 by seismic data analyzer 206. Reports may include, without limitation, ratios 262. Ratios 262 may include Vp/Vp ratios. Time separations 264 may include a difference in arrival times of primary signals reflected from a top and a bottom of a target layer.

Characteristics 266 may include thin bed characteristics. A thin bed characteristic may be a thickness of a thin bed. In an illustrative embodiment, a characteristic of a thin bed may be a type of hydrocarbon in the thin bed. Characteristics 266 that may be determined from the Vp/Vs ratios and the time separations may increase depending on a person skilled in the art's knowledge and experience in using the Vp/Vs ratios and the time separations provided by reports 260.

Seismic data analyzer 206 may transform, via transform data component 208, input multi-component seismic data 220 from time domain 222 into a frequency domain to form frequency domain seismic data 250. Frequency domain seismic data 250 may include measured primary wave spectra 252, measured secondary wave spectra 254, estimated primary wave wave spectra 256, and estimated secondary wave spectra 258. Transform component 208 may perform transformations using Fourier transformations.

Seismic data analyzer 206 may create estimated primary wave spectra 256 from measured secondary wave spectra 254 and estimated secondary wave spectra 256 from measured primary wave spectra 258 using a warp factor. The warp factor may be determined by determine ratio component 210 of seismic data analyzer 206. Determine ratio component 210 may use a warp factor to compare estimated primary wave spectra 256 to measured primary wave spectra 252 and to determine a first number of correlation values. Determine ratio component 210 may use another warp factor to plot correlations of estimated secondary wave spectra 258 to measured secondary wave spectra 254 and to determine a second number of correlation values. Determine ratio component 210 may plot the first number of correlation values against a first number of trial Vp/Vs ratios. Determine ratio component 210 may plot the second number of correlation values against a second number of trial Vp/Vs ratios. Determine ratio component 210 may use a highest correlation value to identify a corresponding Vp/Vs ratio. Seismic data analyzer may use a warp factor associated with the Vp/Vs ratio to calculate a time separation for primary wave signals from a top and a bottom of the target depth interval. Such a calculation may be made by determine characteristics component 212.

In these illustrative examples, group of features 234 may be used by determine ratio component 210. Determine ratio component 210 may be configured by configuration component 230 to use one or more of troughs 236, peaks 238, slopes 240, and other features 242. As used herein a “group” used with reference to items means one or more items. For example, “group of features 234” may include one or more groups. A group of features may take various forms.

Further, other types of processing may be performed by seismic data analyzer 206. For example, seismic data analyzer 206 may also remove noise or other unwanted data from input multi-component seismic data 220.

The illustration of seismic analysis system in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an advantageous embodiment.

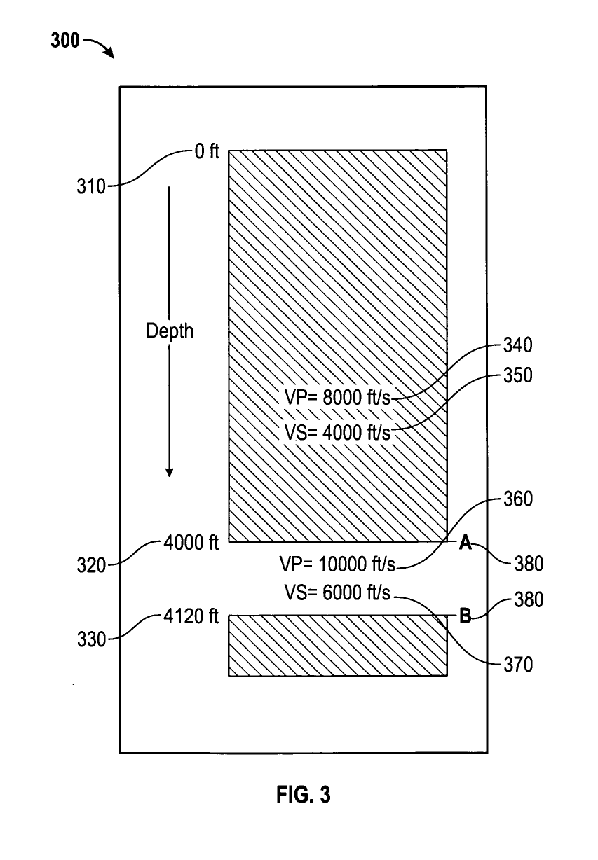

Referring to FIG. 3, an illustration of a depth model in accordance with an illustrative embodiment is depicted. Depth model 300 depicts three depths, 0 feet 310, 4000 feet 320, and 4120 feet 330. A layer of interest 380 is shown between line A and line B. In an illustrative embodiment, a layer of interest may be a thin bed. Velocity of primary waves between 0 feet 310 and 4000 feet 320 is 8000 feet/second for primary waves 340 and 4000 feet per second for secondary waves 350. Between line A and line B, in area of interest 380, velocity of primary wave is 10000 feet per second 360 and the velocity of the secondary wave is 6000 feet per second 370. Therefore, a Vp/Vs ratio for area of interest 380 would be 10000/6000 or 1.666.

Referring to FIG. 4, an illustration of a flow chart for transforming data in accordance with an illustrative embodiment is depicted. Transform process 400 starts (step 402) and receives primary wave data and secondary wave data from multi-component receivers in a time domain (step 410). Transform process 400 converts, by a first Fourier transform, the primary wave data in a time domain into a primary wave spectrum in a frequency domain (step 420). Transform process 400 converts, by a second Fourier transform, the secondary wave data in the time domain into a secondary wave spectrum in the frequency domain (step 430). Transform process stops (step 440).

Referring to FIG. 5, an illustration of a flow chart for determining ratios in accordance with an illustrative embodiment is depicted. Ratios process 500 starts (step 502) and selects travel times (step 510). Persons skilled in the art recognize and take into account that a first set of two-way travel times for a first set of reflections of primary wave data corresponding to a target depth interval may be selected. The first set of two-way travel times may be selected using velocities derived from seismic processing, primary wave sonic logs, check-shot surveys, known seismic markers, or other methods known to persons skilled in the art. Furthermore, persons skilled in the art recognize and take into account that a second set of two-way travel times for a second set of reflections of secondary wave data corresponding to the target depth interval may be selected. Moreover, the second set of two-way travel times may be selected using a second set of velocities derived from seismic multi-component processing, conversion of primary wave velocities to secondary wave velocities using mudline equations, secondary wave sonic logs, known seismic markers, or other methods known to persons skilled in the art.

Ratios process 500 selects a number of trial Vp/Vs values from a range having an initial value and an end value and a number of substantially equidistant values between the initial value and the end value (step 520). Ratios process 500 calculates the warp factor using a formula 2/(1+(Vp/Vs))=α, where α is the warp factor, and each of a number of values for the warp factor are calculated using one of the number of trial Vp/Vs values (step 530). In an illustrative embodiment, an estimated primary wave spectrum, Pest(f) is derived from measured secondary wave spectrum, S(f/a), where f is frequency in hertz (Hz) and α is a warp factor. Alternatively, an estimated secondary wave Sest(f) may be derived from a measured primary wave spectrum, P(αf), where f is frequency in Hz and α is a warp factor. As explained above, the VP/VS ratio may be determined by exchanging the role of the primary and secondary wave spectra. That is, secondary wave spectra may be estimated from the measured primary wave spectrum and the estimated secondary wave spectra may be correlated to the measured secondary wave spectrum as set forth above.

Ratios process 500 creates a first number of estimated primary wave spectra from measured secondary wave spectrum using a first warp factor and/or creates a second number of estimated secondary wave spectra from measured primary wave spectra (step 540). Measured primary wave spectra may be measured primary wave spectra 252 in FIG. 2. Measured secondary wave spectra may be measured secondary wave spectra 254 in FIG. 2. Estimated primary wave spectra may be estimated primary wave spectra 256 in FIG. 2. Estimated secondary wave spectra may be estimated secondary wave spectra 258 in FIG. 2.

Ratios process 500 compares each of the estimated primary wave spectra with the measured primary wave spectrum to obtain a number of first correlation values. Ratios process 500 may also compare each of the estimated secondary wave spectra to a measured secondary wave spectrum to obtain a second number of correlation values. Each correlation value in the first correlation values and each correlation value in the second correlation values corresponds to one of a number of trial Vp/Vs values (step 550). Ratios process 500 plots each of the number of correlation values against each of the number of trial Vp/Vs values (step 560). Ratios process 500 identifies a segment of the plot as a peak correlation (step 570). Ratios process 500, responsive to identifying the segment of the plot as the peak correlation, identifies a trial Vp/Vs value that corresponds to the peak correlation (step 580). Ratios process 500, responsive to identifying the trial Vp/Vs value that corresponds to the peak correlation, designates the trial Vp/Vs value as the Vp/Vs ratio for the target depth interval (step 590). Ratios process 500 stops (step 592).

Referring to FIG. 6, an illustration of a flow chart for determining time separations in accordance with an illustrative embodiment is depicted. Time separation process 600 starts (step 602), and identifies a trough in the measured secondary wave spectrum used in ratios process 500 in FIG. 5 (step 610). Using the plot created in step 560 of FIG. 5, and the Vp/Vs ratio identified in step 580 of FIG. 5, time separation process 600 identifies a warp factor corresponding to the Vp/Vs ratio for the target depth interval identified in step 590 of FIG. 5 (step 620). Time separation process 600 identifies a frequency at a lowest point of the trough identified in step 610 (step 630). Time separation process calculates a time separation for the secondary signal by dividing the frequency at the lowest point of the trough into 1.0 (step 640). Time separation process calculates a time separation for the primary signal of FIG. 5 by multiplying the time separation for the secondary signal by the warp factor (step 650). Time separation process 600, using the time separation for the primary signal calculated in step 650, determines a characteristic of the target depth interval (step 660) and stops (step 670). Time separation process 600 may display a report such as time separation 264 and/or characteristics 266 in FIG. 2. Determining a characteristic of the target depth interval may be an estimate of a thickness of a thin bed. Determining a characteristic of the target depth interval may identify hydrocarbons in the target depth interval. Such determinations are based on the time separation for the primary signal calculated in step 650.

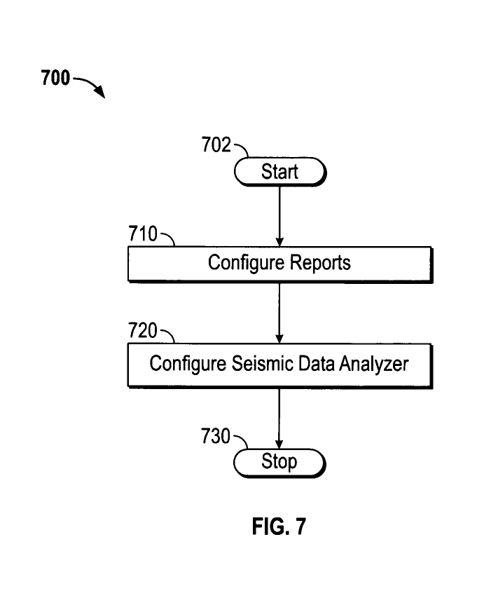

Referring to FIG. 7, an illustration of a flow chart for configuring seismic analysis system is depicted. Configuring seismic analysis system 700 starts (step 702) and configures report (step 710), configures seismic data analyzer (step 720), and stops (step 730). Configuration component 700 may receive input from users and computers within computer system 202 in FIG. 2. Examples of configuration may be reports specifying Vp/Vs ratios for a specified number of time intervals and locations, a description of feature characteristics derived by comparing a Vp/Vs ratio calculated by seismic data analyzer 206 to a database of previously gathered seismic data, or other types of reports desired by a user employing the advantages of seismic data analyzer 206. In a further example, seismic data analyzer 206 may be configured by selection of comparison techniques for correlation of estimated primary wave spectra 256 or estimated secondary wave spectra 258 to measured primary wave spectra 252 or measured secondary wave spectra 254.

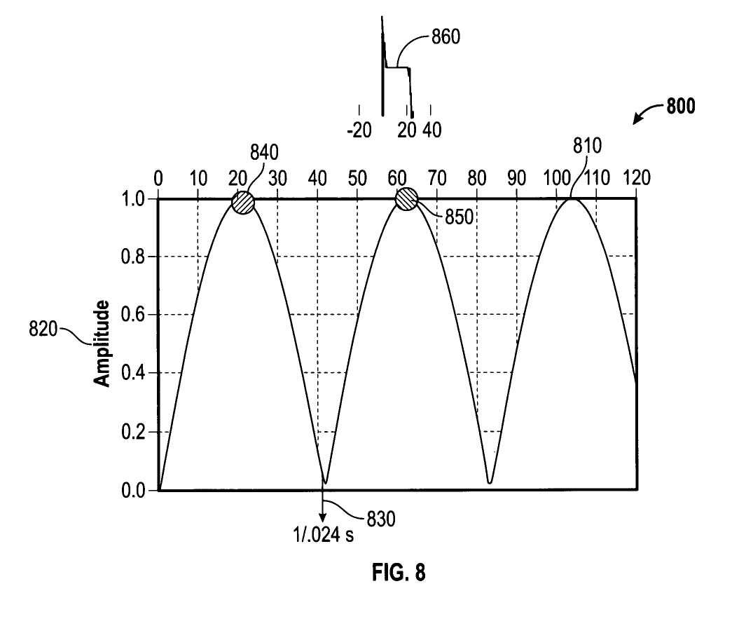

Referring to FIG. 8, an illustration of a primary signal in the time domain with its corresponding frequency spectrum in accordance with an illustrative embodiment is depicted. Primary signal 860 has been transformed by Fourier transform into a primary wave spectrum 800 depicted as a waveform plot of normalized amplitude 820 versus frequency 810. Arrow 830 indicates a frequency of 1/0.024 seconds. Peaks 840 and 850 have a normalized amplitude value of 1.0.

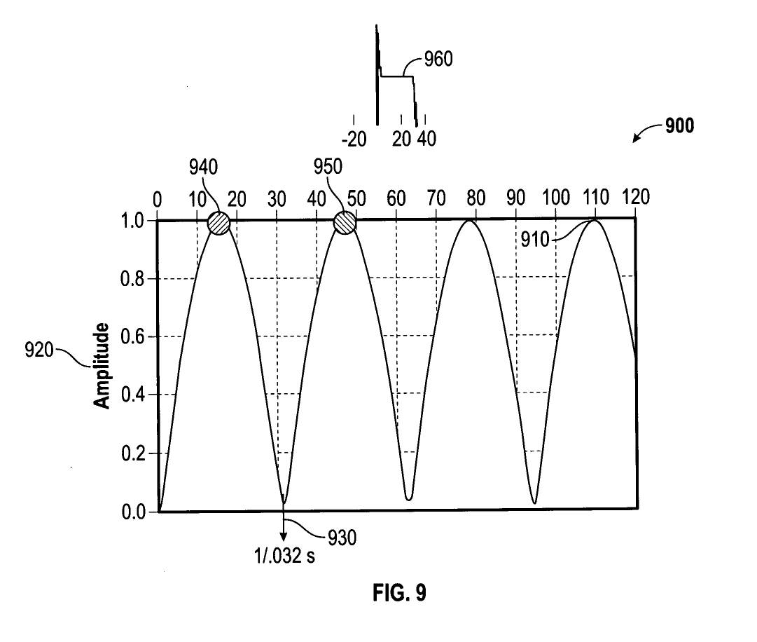

Referring to FIG. 9, an illustration of a secondary signal in the time domain and its corresponding frequency spectrum in the frequency domain in accordance with an illustrative embodiment is depicted. Secondary signal 960 has been transformed by Fourier transform into a secondary wave spectrum 900 depicted as a waveform plot of normalized amplitude 920 versus frequency 910. Arrow 930 indicates a frequency of 1/0.032 seconds. Peaks 940 and 950 have a normalized amplitude value of 1.0. Peaks 940 and 950 may be correlated to peaks 840 and 850 in FIG. 8. Likewise, arrow 930 may be correlated with arrow 830 in FIG. 8.

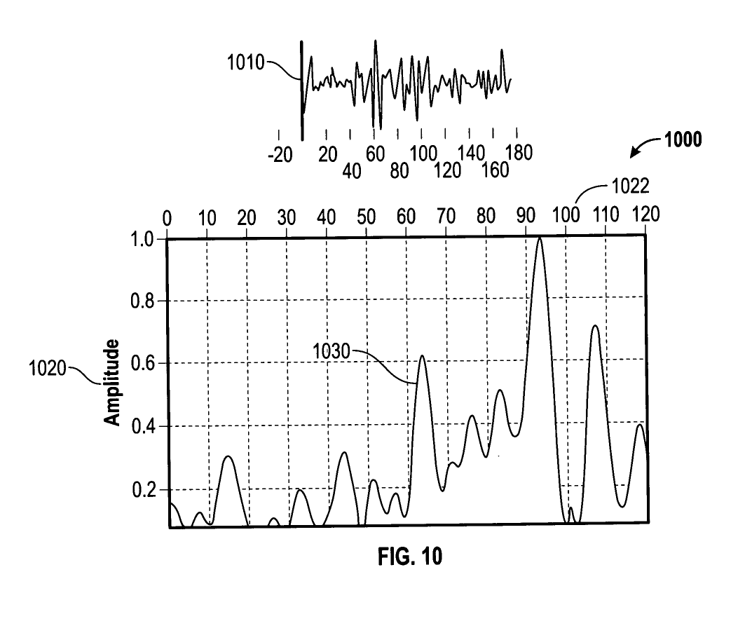

Referring to FIG. 10, an illustration of a thick bed primary signal in the time domain and its corresponding frequency spectrum in accordance with an illustrative embodiment is depicted. Primary signal 1010 has been transformed by Fourier transform into primary wave spectrum 1030 in display 1000. Primary wave spectrum 1030 may be plotted by amplitude 1020 against frequency 1022. Amplitude 1020 may be normalized.

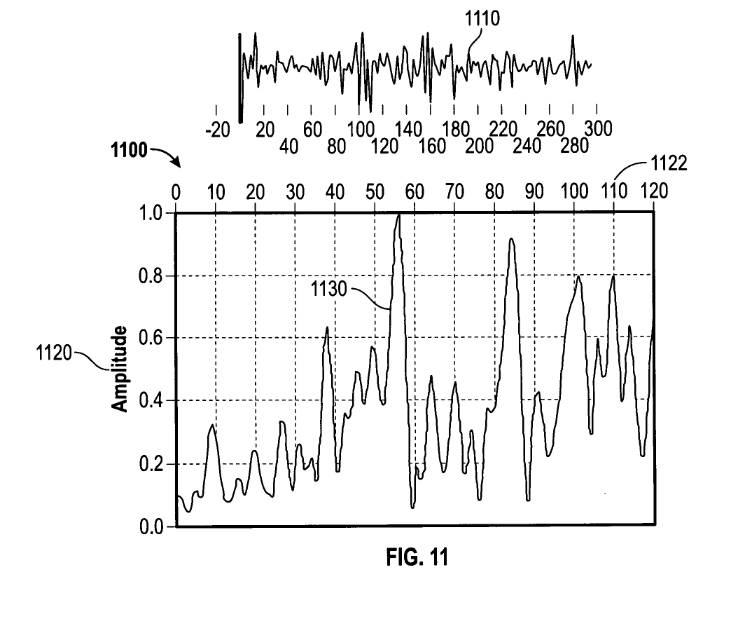

Referring to FIG. 11, an illustration of a thick bed secondary signal in the time domain and its corresponding frequency spectrum in accordance with an illustrative embodiment is depicted. Secondary signal 1110 comes from the same depth interval as primary signal 1010 in FIG. 10. Secondary signal 1110 has been transformed by Fourier transform into secondary wave spectrum 1130 in display 1100. Secondary wave spectrum 1030 may be plotted by amplitude 1120 against frequency 1122. Amplitude 1120 may be normalized.

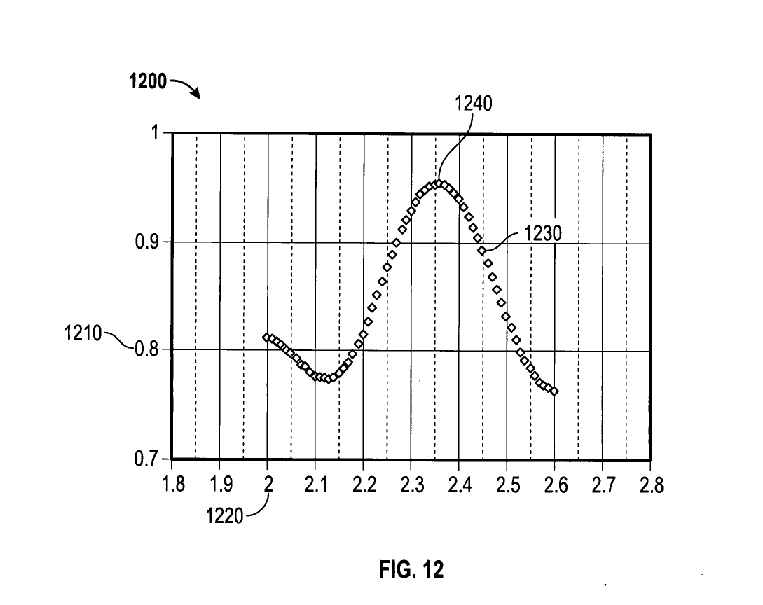

Referring to FIG. 12, an illustration of a plot of correlation values versus trial Vp/Vs ratios in accordance with an illustrative embodiment is depicted. Plot 1230 in display 1200 is generated using seismic data analyzer 206 in FIG. 2 and ratio process 500 depicted in FIG. 5. Correlations 1210 are plotted against trial Vp/Vs ratios 1220. Point 1240 is the peak correlation area of plot 1230.

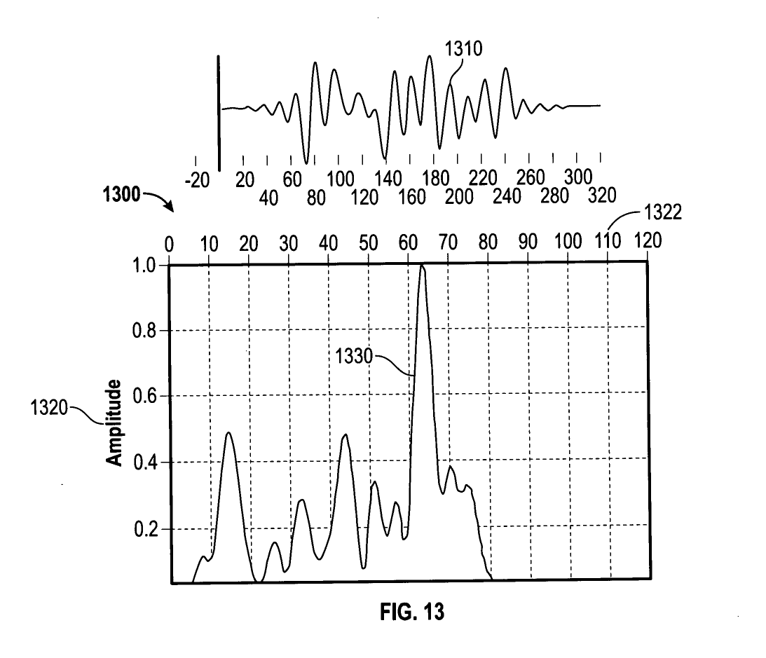

Referring to FIG. 13, an illustration of a thick bed primary signal in the time domain and its corresponding frequency spectrum in accordance with an illustrative embodiment is depicted. Primary signal 1310 is an Ormsby filtered version of primary signal 1010 in FIG. 10. Primary signal 1310 has been transformed by Fourier transform into primary wave spectrum 1330 in display 1300. Primary wave spectrum 1030 may be plotted by amplitude 1320 against frequency 1322. Amplitude 1320 may be normalized.

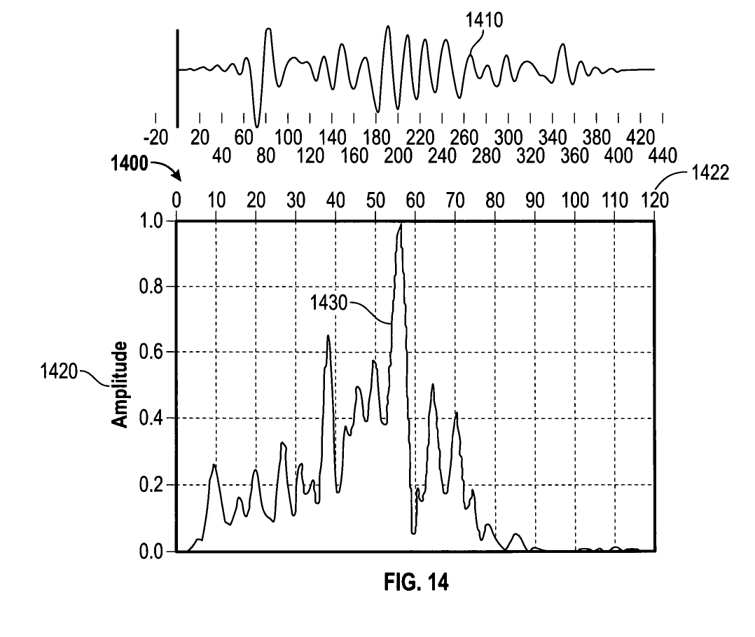

Referring to FIG. 14, an illustration of thick bed secondary signal in the time domain and its corresponding frequency spectrum in accordance with an illustrative embodiment is depicted. Secondary signal 1410 is an Ormsby filtered version of secondary signal 1110. Secondary signal 1410 has been transformed by Fourier transformation into secondary wave spectrum 1430 in display 1400. Secondary wave spectrum 1430 may be plotted by amplitude 1420 against frequency 1422. Amplitude 1420 may be normalized.

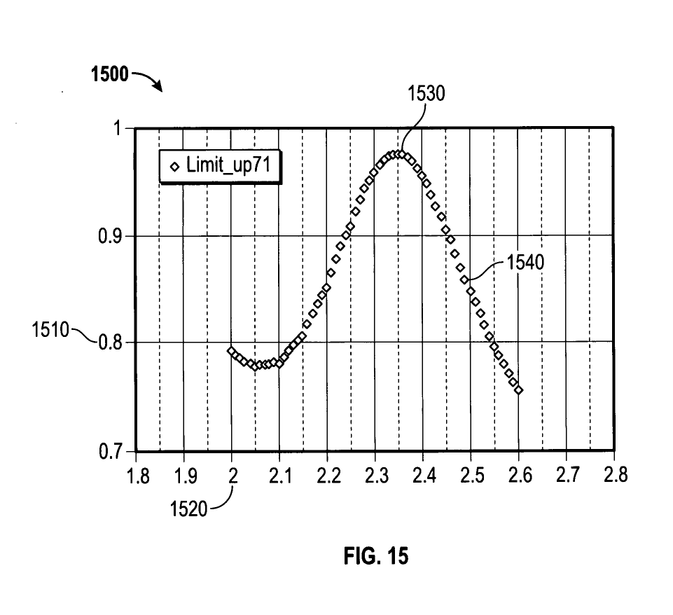

Referring to FIG. 15, an illustration of a plot of correlation versus trial Vp/Vs ratios in accordance with an illustrative embodiment is depicted. Plot 1530 in display 1500 is generated using seismic data analyzer 206 in FIG. 2 and ratios process depicted in FIG. 5. Correlations 1510 are plotted against trial Vp/Vs ratios 1520. Point 1530 is the peak correlation area of plot 1540.

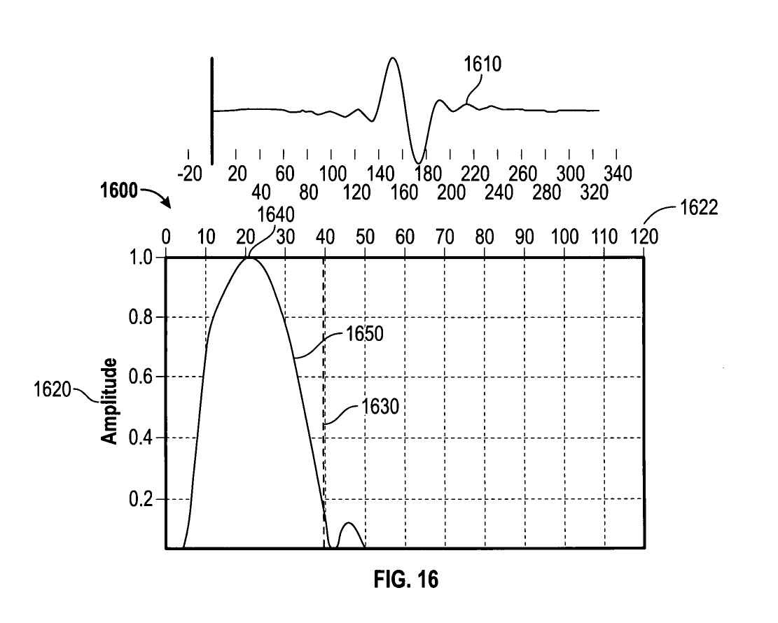

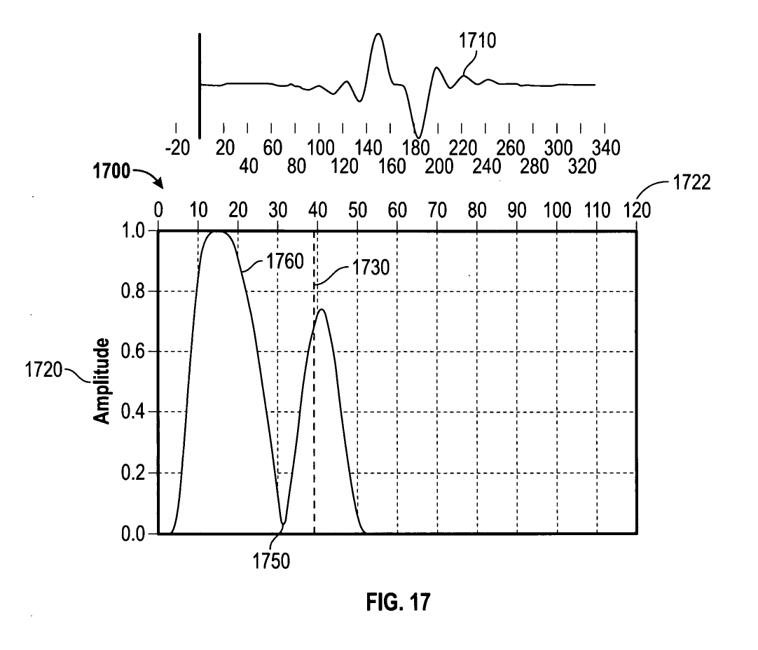

Referring to FIG. 16, an illustration of a thin bed primary signal with an Ormsby filter in the time domain and its corresponding frequency spectrum in accordance with an illustrative embodiment is depicted. Primary signal 1610 corresponds to primary seismic response from the depth model shown in FIG. 3. Primary signal 1610 has been transformed by Fourier transformation into primary wave spectrum 1650. Primary wave spectrum 1650 may be plotted by amplitude 1620 against frequency 1622. Amplitude 1620 may be normalized. Line 1630 at 40 hertz may be compared to line 1730 at 40 Hertz in FIG. 17.

Referring to FIG. 17, an illustration of a thin bed secondary signal with an Ormsby filter in the time domain and its corresponding frequency spectrum in accordance with an illustrative embodiment is depicted. Secondary signal 1710 corresponds to secondary seismic response from the depth model shown in FIG. 3. Secondary signal 1710 has been transformed by Fourier transformation into secondary wave spectrum 1760. Secondary wave spectrum 1760 may be plotted by amplitude 1720 against frequency 1722. Amplitude 1720 may be normalized. Line 1730 at 40 Hertz may be compared to line 1630 at 40 hertz in FIG. 16.

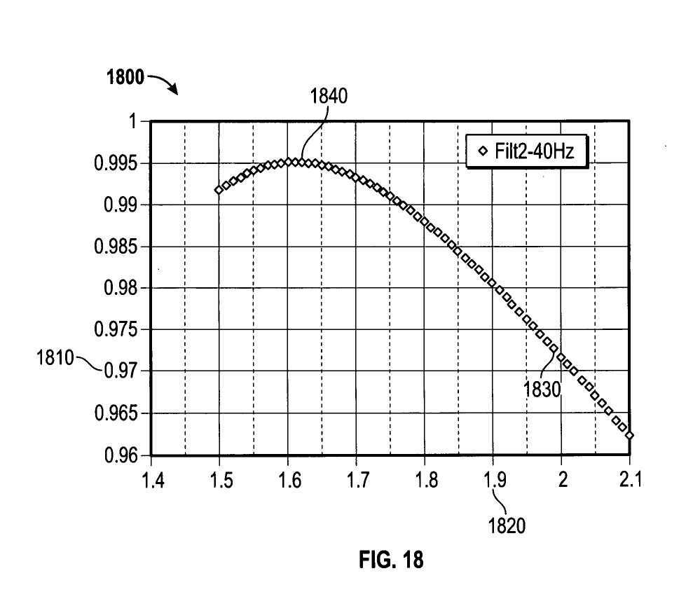

Referring to FIG. 18, an illustration of a plot of correlation values versus trial Vp/Vs ratios in accordance with an illustrative embodiment is depicted. Plot 1830 in display 1800 is generated using seismic data analyzer 206 in FIG. 2 and ratios process 500 depicted in FIG. 5. Correlations 1810 are plotted against trial Vp/Vs ratios 1820. Point 1840 is the peak correlation area of plot 1830.

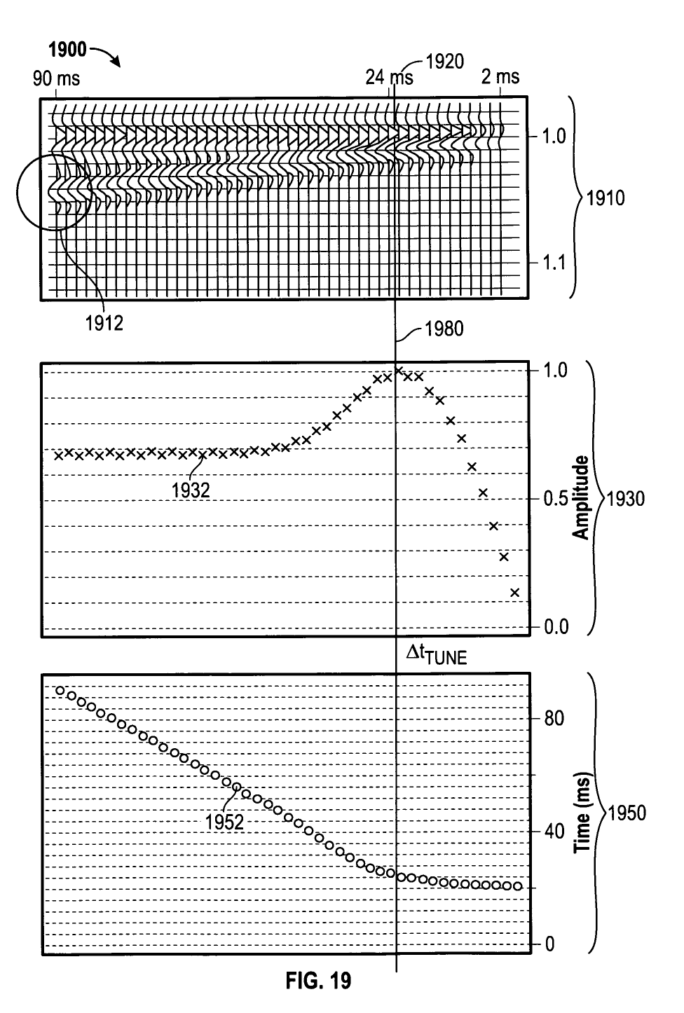

Referring to FIG. 19, a series of reflections from a thin bed with varying two-wave travel times between a top and a bottom boundary of the thin bed are depicted in accordance with an illustrative embodiment. In first portion 1910 of FIG. 19, the two-way bed travel times range from 90 milliseconds to 2 milliseconds for seismic wavelet 1912. In the illustrative embodiment, first portion 1910 of FIG. 19 may represent a primary signal from a peak and a trough of a target layer having the shape of a wedge. In the illustrative embodiment, the bed is a geologic bed ranging from 450 feet to 10 feet. Therefore, the two-way travel time between the peak boundary and the trough boundary of the wedge may vary from 90 milliseconds to 2 milliseconds. The wedge in FIG. 19 has a Vp=10000 feet per second and a VS=5000 feet per second yielding a Vp/Vs=2 and a warp factor=0.67 for measured primary and secondary waves.

In second portion 1930 of FIG. 19, plot 1932 of amplitude versus two-way travel time is illustrated. Amplitude for each two-way travel time trace is measured by taking the amplitude difference between the peak and the trough amplitudes. When the reflections from the top and bottom are visually separated, the measured amplitude, which is plotted, remains constant. When the thin bed has a travel time of 24 milliseconds 1920, the amplitude difference reaches a maximum, which is referred to as a tuning amplitude. The travel time at the tuning amplitude may be named Δt_{TUNE}. In an embodiment, Δt_{TUNE} may be approximately ½ a dominant seismic wavelet period. Line 1980 represents tuning amplitude location in first section 1910, second section 1930, and third section 1950.

In third section 1950 of FIG. 19, the peak-to-trough time difference has been measured and plotted as plot 1952. At the true travel time of 90 milliseconds, the measured travel time is 90 milliseconds. From 90 milliseconds to 24 milliseconds, the measured time separation between the upper boundary and the bottom boundary is a true two-way travel time. However, for true travel times less than 24 milliseconds such as shown to the right of line 1980, the measured time separation remains at approximately 24 milliseconds. Thus target depth layers less than 24 milliseconds cannot be estimated by measured primary wave time separation. As the travel time in the thin bed becomes smaller, the measured travel time between the peak and trough remains approximately constant once the true travel time reaches Δt_{TUNE}. The minimum travel time separation for the thin bed that is possible to measure that matches the true travel time is Δt_{TUNE}, which relates to the spectra of the seismic wavelet. This separation may be referred to as the tuning “thickness.” The secondary signal for the wedge in first portion 1910 of FIG. 19 has time separation from 90 milliseconds to 2 milliseconds which now represents thickness from (450×0.67) feet to (10×0.67) feet. The corresponding secondary seismic wavelet will be the same as the primary seismic wavelet so that Δt_{TUNE}=24 milliseconds. For the secondary signal, the lower limit of the peak-to-trough separation would still be 24 milliseconds, the same as for the primary signal. However, 24 milliseconds for the secondary wave corresponds to a thickness of 120 feet times the warp factor or 120 times 0.67=80 feet.

Using peak and trough separation, secondary waves may be used to estimate beds as thin as 80 feet, while primary waves may be used to estimate beds as thin as 120 feet. Therefore, an estimate of a thin bed thickness may be determined with greater accuracy using a secondary wave time separation. The thickness that can be estimated using the primary signal is 1.5 times (1/warp factor) the thickness that can be estimated by the secondary signal. Persons skilled in the art recognize and take into account that resolution may be used in the relevant industry to mean estimation. Using the Vp/Vs ratio as determined in FIG. 5, a person skilled in the art can estimate smaller variations of thin-bed time separation expressed for primary wave velocity. As explained above in FIG. 6, a trough frequency is determined from the secondary wave spectrum, and used in conjunction with the warp factor determined in FIG. 5, to calculate a time separation for a primary wave to estimate thin bed thickness.

In FIG. 19, a thin bed reflection series is shown for the primary wave. This time series without a typical seismic wavelet convolved with it is shown in FIG. 8. The travel time separation between the top and bottom reflections is 24 milliseconds. This travel time corresponds to the trough shown in the frequency spectrum of FIG. 8 and also in FIG. 16.

In a similar fashion, a thin bed secondary signal with an Ormsby filter in the time domain and its corresponding frequency spectrum was shown in FIG. 17. A similar time series without a seismic wavelet is shown in FIG. 9. The travel time separation between the top and bottom reflections is 32 milliseconds. This travel time corresponds to the trough shown in the frequency spectrum of FIG. 9 and also in FIG. 17.

The primary time series in FIG. 16 corresponds to the seismic trace marked 24 milliseconds in the upper part of FIG. 19. The minimum travel time that is possible to correctly measure by trough-to-peak time separation would be 24 milliseconds for the seismic wavelet shown. Now, the secondary time series shown in FIG. 17, with a travel time in the thin bed of 32 milliseconds, would correspond to a trace to the left of the 24 milliseconds trace in first section 1910 of FIG. 19. The peak-to-trough measured time separation for the trace in FIG. 9 would then match the true time separation.

Persons skilled in the art recognize and take into account that there is a slight correction to the measured travel times when the time separation of the thin bed approaches the tuning thickness as shown by the deviation of the time separation measurement 1952 of FIG. 19 on the left side of line 1980 from a straight line.

In the example of FIG. 19, the minimum travel time predicted in the time domain for the thin bed separation may be 24 milliseconds for the primary reflection. The thin bed travel time for the secondary reflection may be to the left of the tuning thickness and may be a time separation of 32 milliseconds. If the secondary wave reflection is used to measure time separation of the thin bed, then the measured time, 32 milliseconds, is multiplied by a warp factor 0.75 to obtain the desired travel time of 24 milliseconds in the primary travel time.

In an embodiment, a method to determine the primary travel time in the thin bed may be to measure the trough frequency in the secondary time series as shown in FIG. 17 and to take the reciprocal to get the secondary travel time for the thin bed. This would be 1/31.25 Hertz or 32 milliseconds. 32 milliseconds may be multiplied by a warp factor to obtain the desired primary travel time in the thin bed. Using the secondary time series or the spectrum of the secondary time series to determine the primary travel time require the VP/VS ratio and warp factor as set forth above in FIG. 4 through FIG. 6.

Seismic data analyzer 206 (see FIG. 2) provides increased resolution is directly related to the warp factor as illustrated in step 540 of FIG. 5 and in step 620 of FIG. 6. The minimum travel time resolvable from seismic data analyzer 206 in FIG. 2 employing the methods set forth in FIG. 4 through FIG. 6 is a warp factor times the minimum travel time by primary wave time series or primary spectrum analyses. For a typical VP/VS ratio of 2, a warp factor may be 0.67 and 1/warp factor=1.50. Persons skilled in the art recognize and take into account that multi-component seismic data analysis performed by seismic data analyzer 206 of FIG. 2 may provide an increase in a time resolution of approximately fifty percent over methods that do not use multi-component seismic data.

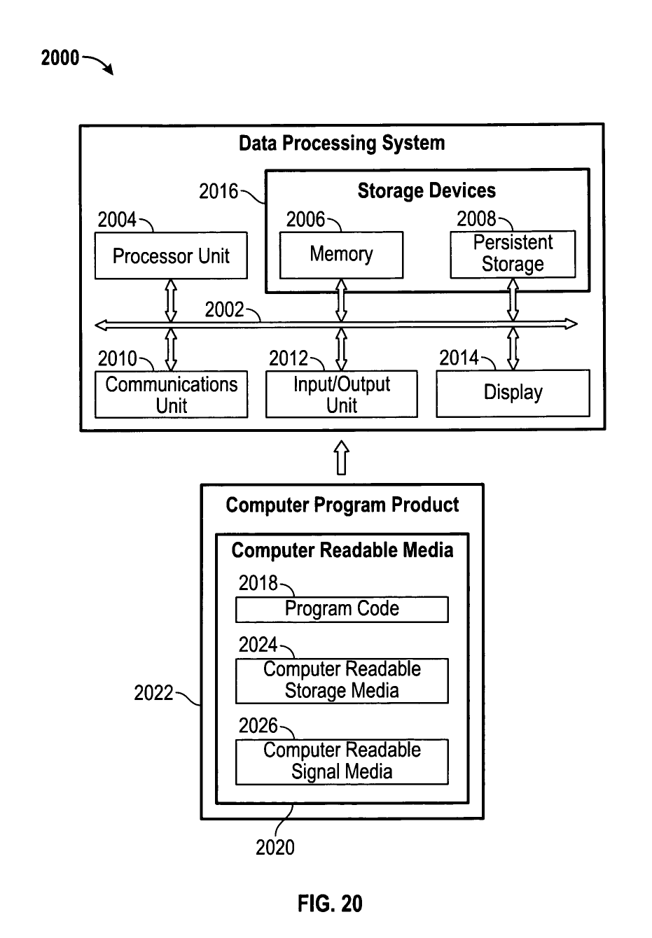

Turning now to FIG. 20, an illustration of a data processing system is depicted in accordance with an advantageous embodiment. Data processing system 2000 may be used to implement computer system 202 with number of computers 204 in FIG. 2. In this illustrative example, data processing system 2000 includes communications framework 2002, which provides communications between processor unit 2004, memory 2006, persistent storage 2008, communications unit 2010, input/output (I/O) unit 2012, and display 2014. In this example, communication framework may take the form of a bus system.

Processor unit 2004 serves to execute instructions for software that may be loaded into memory 2006. Processor unit 2004 may be a number of processors, a multi-processor core, or some other type of processor, depending on the particular implementation.

Memory 2006 and persistent storage 2008 are examples of storage devices 2016. A storage device is any piece of hardware that is capable of storing information, such as, for example, without limitation, data, program code in functional form, and/or other suitable information either on a temporary basis and/or a permanent basis. Storage devices 2016 may also be referred to as computer readable storage devices in these illustrative examples. Memory 2006, in these examples, may be, for example, a random access memory or any other suitable volatile or non-volatile storage device. Persistent storage 2008 may take various forms, depending on the particular implementation.

For example, persistent storage 2008 may contain one or more components or devices. For example, persistent storage 2008 may be a hard drive, a flash memory, a rewritable optical disk, a rewritable magnetic tape, or some combination of the above. The media used by persistent storage 2008 also may be removable. For example, a removable hard drive may be used for persistent storage 2008. In an illustrative embodiment, persistent storage 2008 may contain seismic data analyzer 206 including transform data component 208, determine ratio component 210, and determine characteristic component 212. Moreover, persistent storage may contain input multi-component seismic data 220 and frequency domain seismic data 250. Persistent storage 2008 may further contain configuration component 230 and reports 260.

Communications unit 2010, in these illustrative examples, provides for communications with other data processing systems or devices. In these illustrative examples, communications unit 2010 is a network interface card.

Input/output unit 2012 allows for input and output of data with other devices that may be connected to data processing system 2000. For example, input/output unit 2012 may provide a connection for user input through a keyboard, a mouse, and/or some other suitable input device. Further, input/output unit 2012 may send output to a printer. Display 2014 provides a mechanism to display information to a user.

Instructions for the operating system, applications, and/or programs may be located in storage devices 2016, which are in communication with processor unit 2004 through communications framework 2002. The processes of the different embodiments may be performed by processor unit 2004 using computer-implemented instructions, which may be located in a memory, such as memory 2006.

These instructions are referred to as program code, computer usable program code, or computer readable program code that may be read and executed by a processor in processor unit 2004. The program code in the different embodiments may be embodied on different physical or computer readable storage media, such as memory 2006 or persistent storage 2008. Program code may contain instructions for the transform component 208, determine ratios component 210, and determine characteristics component 212 in FIG. 2, so that processor unit 2004 may carry out the features illustrated in FIG. 4 through FIG. 6.

Program code 2018 is located in a functional form on computer readable media 2020 that is selectively removable and may be loaded onto or transferred to data processing system 2000 for execution by processor unit 2004. Program code 2018 and computer readable media 2020 form computer program product 2022 in these illustrative examples. In one example, computer readable media 2020 may be computer readable storage media 2024 or computer readable signal media 2026.

In these illustrative examples, computer readable storage media 2024 is a physical or tangible storage device used to store program code 2018 rather than a medium that propagates or transmits program code 2018.

Alternatively, program code 2018 may be transferred to data processing system 2000 using computer readable signal media 2026. Computer readable signal media 2026 may be, for example, a propagated data signal containing program code 2018. For example, computer readable signal media 2026 may be an electromagnetic signal, an optical signal, and/or any other suitable type of signal. These signals may be transmitted over communications links, such as wireless communications links, optical fiber cable, coaxial cable, a wire, and/or any other suitable type of communications link.

The different components illustrated for data processing system 2000 are not meant to provide architectural limitations to the manner in which different embodiments may be implemented. The different advantageous embodiments may be implemented in a data processing system including components in addition to and/or in place of those illustrated for data processing system 2000. Other components shown in FIG. 20 can be varied from the illustrative examples shown. The different embodiments may be implemented using any hardware device or system capable of running program code 2018. Additionally, as used herein, and in accordance with an illustrative example, processor unit 2004 can comprise a distributed processor unit 2004 with a portion implemented on local computer system 101 and a portion on remote computer 102.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible computer readable medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for determining a characteristic of a target layer, the method comprising:
a computer receiving primary wave data and secondary wave data from multi-component receivers for acquiring both primary wave data and secondary wave data in a seismic exploration system;
the computer calculating a Vp/Vs ratio by correlating in a frequency domain a number of estimated primary wave spectra, derived from a measured secondary wave spectrum, to a measured primary wave spectrum, wherein Vp is a first velocity of a primary wave and Vs is a second velocity of a secondary wave for a target depth interval; and
the computer, using a warp factor associated with the Vp/Vs ratio, calculating a time separation for primary wave signals from a top and a bottom of the target depth interval.

2. The method of claim 1, wherein the step of calculating the time separation for primary wave signals from the top and the bottom of the target depth interval further comprises:
the computer identifying a trough in the measured secondary wave spectrum;
the computer identifying a frequency at a substantially lowest point of the trough;
the computer calculating a first time separation for the secondary signal by dividing the frequency into 1.0;
the computer calculating a second time separation by multiplying the first time separation by the warp factor; and
the computer using the second time separation, determining the characteristic of the target layer.

3. The method of claim 2, wherein the characteristic is a thickness, and the target layer is a thin bed.

4. The method of claim 1 further comprising:
the computer converting, by a first Fourier transform, the primary wave data in a time domain into a primary wave spectrum in a frequency domain; and
the computer converting, by a second Fourier transform, the secondary wave data in the time domain into a secondary wave spectrum in the frequency domain.

5. The method of claim 1, wherein the step of the computer calculating the Vp/Vs ratio by correlating in the frequency domain the number of estimated primary wave spectra derived from the measured secondary wave spectrum to the measured primary wave spectrum, further comprises:
the computer selecting the interval on the primary wave frequency spectrum;
the computer, creating the number of estimated primary wave frequency spectra using a warp factor;
the computer comparing each of the estimated primary wave frequency spectra with the actual primary wave spectra to obtain a number of correlation values, wherein each correlation value corresponds to one of the number of trial Vp/Vs values;
the computer plotting each of the number of correlation values against each of the number of trial Vp/Vs values;
the computer identifying a segment of the plot as a peak correlation;
the computer, responsive to identifying the segment of the plot as the peak correlation, identifying a trial Vp/Vs value that corresponds to the peak correlation; and
responsive to identifying the trial Vp/Vs value that corresponds to the peak correlation, designating the trial Vp/Vs value as the Vp/Vs ratio for the target depth interval.

6. The method of claim 5, further comprising:
calculating the warp factor using a formula 2/(1+(Vp/Vs))=α, where α is the warp factor, and each of a number of values for the warp factor are calculated using one of a number of trial Vp/Vs values, wherein the number of trial Vp/Vs values are selected from a range having an initial value and an end value and a number of substantially equidistant values between the initial value and the end value.

7. A method for determining a characteristic of a target layer, the method comprising:
a computer receiving primary wave data and secondary wave data from multi-component receivers for acquiring both primary wave data and secondary wave data in a seismic exploration system;
the computer calculating a Vp/Vs ratio by correlating in a frequency domain a number of estimated secondary wave spectra, derived from a measured primary wave spectrum, to a measured secondary wave spectrum, wherein Vp is a first velocity of the primary wave and Vs is a second velocity of the secondary wave for a target depth interval; and
the computer, using a warp factor associated with the Vp/Vs ratio, calculating a time separation for primary wave signals from a top and a bottom of the target depth interval.

8. The method of claim 7, wherein the step of calculating the time separation for primary wave signals from the top and the bottom of the target depth interval further comprises:
the computer identifying a trough in the measured secondary wave spectrum;
the computer identifying a frequency at a substantially lowest point of the trough;
the computer calculating a first time separation for the secondary signal by dividing the frequency into 1.0;
the computer calculating a second time separation by multiplying the first time separation by the warp factor; and
the computer using the second time separation, determining the characteristic of the target layer.

9. The method of claim 8, wherein the characteristic is a thickness, and the target layer is a thin bed.

10. The method of claim 7, further comprising:
the computer converting, by a first Fourier transform, the primary wave data in a time domain into a primary wave spectrum in a frequency domain; and
the computer converting, by a second Fourier transform, the secondary wave data in the time domain into a secondary wave spectrum in the frequency domain.

11. The method of claim 7, wherein the step of the computer calculating the Vp/Vs ratio by correlating in the frequency domain the number of estimated secondary wave spectra derived from the measured primary wave spectrum to the measured secondary wave spectrum, further comprises:
the computer selecting an interval on the measured primary wave frequency spectrum;
the computer, creating a number of estimated secondary wave frequency spectra using a warp factor;
the computer comparing each of the number of estimated secondary wave frequency spectra with the measured secondary wave spectra to obtain a number of correlation values, wherein each correlation value corresponds to one of the number of trial Vp/Vs values;
the computer plotting each of the number of correlation values against each of the number of trial Vp/Vs values;
the computer identifying a segment of the plot as a peak correlation;
the computer, responsive to identifying the segment of the plot as the peak correlation, identifying a trial Vp/Vs value that corresponds to the peak correlation; and
responsive to identifying the trial Vp/Vs value that corresponds to the peak correlation, designating the trial Vp/Vs value as the Vp/Vs ratio for the target depth interval.

12. The method of claim 11, further comprising:
calculating the warp factor using a formula 2/(1+(Vp/Vs))=α, where α is the warp factor, and each of a number of values for the warp factor are calculated using one of a number of trial Vp/Vs values, wherein the number of trial Vp/Vs values are selected from a range having an initial value and an end value and a number of substantially equidistant values between the initial value and the end value.

13. A computer system comprising one or more processors, one or more computer-readable memories, one or more computer-readable, tangible storage devices and program instructions which are stored on the one or more storage devices for execution by the one or more processors via the one or more memories and when executed by the one or more processors perform the method of claim 1.

14. A computer system comprising one or more processors, one or more computer-readable memories, one or more computer-readable, tangible storage devices and program instructions which are stored on the one or more storage devices for execution by the one or more processors via the one or more memories and when executed by the one or more processors perform the method of claim 7.

15. A computer program product comprising one or more computer-readable, tangible storage devices and computer-readable program instructions which are stored on the one or more storage devices and when executed by one or more processors, perform the method of claim 1.

16. A computer program product comprising one or more computer-readable, tangible storage devices and computer-readable program instructions which are stored on the one or more storage devices and when executed by one or more processors, perform the method of claim 7.
